(19) United States
(12) Patent Application Publication
(10) Pub. No.: US 2025/0122900 A1
(43) Pub. Date: Apr. 17, 2025

(54) NUT RETAINING DEVICE AND RELATED METHODS

(71) Applicant: JPB SYSTÈME, Montereau sur le Jard (FR)

(72) Inventors: Damien Jacky Marc, Blandy Les Tours (FR); Jocelyn Elie Auguste Vecchio, Vitry-Sur-Seine (FR); Nabil Yahiaoui, Bonneuil-Sur-Marne (FR)

(73) Assignee: JPB SYSTÈME, Montereau sur le Jard (FR)

(21) Appl. No.: 18/688,686

(22) PCT Filed: Dec. 3, 2021
(86) PCT No.: PCT/EP2021/084270

§ 371 Date: Mar. 1, 2024

(30) Foreign Application Priority Data
Sep. 14, 2021 (EP) 213151582

(51) Int. Cl. F16B 37/04

(52) U.S. Cl. CPC F16B 37/044

(57) ABSTRACT

Nut retaining devices and related methods are disclosed. An exemplary nut retaining device may include a housing defining an interior receptacle, the housing including attachment structure configured for fixing the housing to a base structure; a nut received within the receptacle and having screw threads for engaging a threaded fastener; retaining structure engageable with the nut and retaining the nut within the receptacle; anti-rotation structure between the housing and the nut constraining the nut against rotation relative to the housing; the anti-rotation structure configured to provide a clearance movement between the nut and the housing in at least one of a rotation direction rotationally about the screwing axis of the nut, or an axial direction parallel to the screwing axis of the nut, or a radial direction relative to the axial direction that is parallel to the screwing axis of the nut.

### FIELD OF THE INVENTION

The present invention relates generally to retaining devices for threaded members and, more particularly, to retaining devices for nuts, and related methods.

### BACKGROUND OF THE INVENTION

The present disclosure contemplates that in certain applications, particularly aeronautical applications such as aircraft engines, some fastenings are assembled by screwing, despite one of the threaded members being very difficult to access. For example, in some installations, a threaded bolt may be screwed into a nut, where the nut is substantially inaccessible by a wrench or other tool to prevent rotation during screwing or unscrewing. As used herein, “nut” may refer to an internally threaded fastener configured to threadedly engage a corresponding externally threaded fastener, such as a bolt.

The present disclosure contemplates that, in some applications, captive nuts may be utilized to allow screwing of a threaded fastener into an inaccessible or not readily accessible nut. However, some known captive nuts may have disadvantages, particularly in aeronautical applications. For example, some captive nut assemblies utilize non-standard nuts. Thus, approval and/or certification (e.g., by civil aviation authorities) may be complicated. Some captive nuts may not readily accommodate variations in dimensional tolerances for adjacent components. For example, nuts that are rigidly secured to a component may require very precise alignment of the corresponding threaded fastener. Other captive nut assemblies may be subject to inadvertent disassembly and/or loss of component parts, such as prior to or during installation or during use. Accordingly, for these and other reasons, there is a need for improved nut retaining devices.

### SUMMARY OF THE INVENTION

The present invention provides nut retaining devices and associated methods. While the invention will be described in connection with certain embodiments, it will be understood that the invention is not limited to these embodiments. Rather, the invention includes all alternatives, modifications, and equivalents as may be included within the spirit and scope of the present disclosure.

It is an aspect of the present disclosure to provide a nut retaining device including a housing defining an interior receptacle, the housing including attachment structure configured for fixing the housing to a base structure; a nut received within the receptacle and having screw threads adapted to engage a correspondingly threaded fastener; anti-rotation structure between the housing and the nut; the anti-rotation structure constraining the nut against rotation relative to the housing about a screwing axis of the nut; the anti-rotation structure configured to provide a clearance movement between the nut and the housing in at least one of: a rotation direction rotationally about the screwing axis of the nut, or an axial direction parallel to the screwing axis of the nut, or a radial direction relative to the axial direction that is parallel to the screwing axis of the nut; and/or retaining structure engageable with the nut and retaining the nut within the receptacle.

In a detailed embodiment, the clearance movement rotationally about the screwing axis may be less than or equal to 7 degrees and/or the clearance movement in the axial direction may be less than or equal to 1.5 mm and/or the clearance movement in the radial direction may be less than or equal to 1.0 mm.

In a detailed embodiment, the anti-rotation structure may include first anti-rotation structure on the housing and/or second anti-rotation structure on the nut. The first and second anti-rotation structures may cooperate to constrain the nut against rotation relative to the housing. The nut retaining device may include an intermediate anti-rotation element received in the receptacle. The intermediate anti-rotation element may include third anti-rotation structure complementary to the first anti-rotation structure on the housing and/or fourth anti-rotation structure complementary to the second anti-rotation structure on the nut. The third anti-rotation structure may engage the first anti-rotation structure to provide the clearance movement between the nut and the housing and/or the fourth anti-rotation structure may engage the second anti-rotation structure to constrain the nut against rotation relative to the intermediate anti-rotation element.

In a detailed embodiment, the intermediate anti-rotation element may be deformed to secure the intermediate anti-rotation element to the nut. The intermediate anti-rotation element may be at least one of press fit, interference fit, welded, or shrink-fit onto the nut. In a detailed embodiment, (a) the first anti-rotation structure on the housing may include a plurality of grooves extending along an axial direction parallel to the screwing axis of the nut, between a second end of the housing adjacent the attachment structure in a direction toward a first end of the housing opposite the second end, and the third anti-rotation structure on the intermediate anti-rotation element may include a plurality of radially outwardly extending protrusions; and/or (b) the second anti-rotation structure may include a plurality of radially outwardly extending splines on the outer surface of the nut, and the fourth anti-rotation structure on the intermediate anti-rotation element may include a plurality of radially inwardly extending protrusions on an inner surface thereof and configured to inter-engage the radially outwardly extending splines on the nut.

In a detailed embodiment, the intermediate anti-rotation element may be sized smaller than the interior dimensions of the receptacle such that a gap is defined between the receptacle and the intermediate element that accommodates the clearance movement in the radial direction. The first anti-rotation structure on the housing may include a plurality of grooves and the third anti-rotation structure may include a plurality of radially outwardly extending protrusions on the intermediate anti-rotation element. The protrusions may have a width in a plane perpendicular to the axial direction that is less than a width of the corresponding groove by an amount that provides the clearance movement in the radial direction.

In a detailed embodiment, the receptacle may define a length in the axial direction relative to the retaining structure that is greater than the dimensions of the intermediate anti-rotation element in the axial direction such that a gap is provided that accommodates the clearance movement in the axial direction.

In a detailed embodiment, the retaining structure may be received within the receptacle and/or may have an outer surface configured to frictionally engage at least a portion of an inner surface of the housing that defines the receptacle such that, when installed within the receptacle, the nut is prevented from being removed from the receptacle. The nut retaining device may include a radially inwardly extending protrusion within the receptacle and defining an axial stop against which the retaining structure is engaged to position the retaining structure within the receptacle.

In a detailed embodiment, the retaining structure may include structure on at least a portion of the housing that is deformable to create an interference that prevents the nut from being removed from the receptacle.

In a detailed embodiment, the nut may be configured to provide a self-locking of the threads when threadedly engaged with a threaded fastener.

It is an aspect of the present disclosure to provide a method of making a nut retaining device including engaging an intermediate anti-rotation element with a nut, the nut having internal screw threads adapted to engage a correspondingly externally threaded fastener and defining a screwing axis; inserting the intermediate anti-rotation element and the nut into a receptacle of a housing, the housing including an attachment structure configured for fixing the housing to a base structure; and/or inserting a retaining structure into the receptacle so that the intermediate anti-rotation element and the nut are retained within the receptacle and the nut is capable of clearance movement relative to the housing in at least one of: a rotation direction rotationally about the screwing axis of the nut, and/or an axial direction parallel to the screwing axis of the nut, and/or a radial direction relative to the axial direction that is parallel to the screwing axis of the nut.

In a detailed embodiment, the intermediate anti-rotation element may be generally ring shaped, may define a radially inner surface, and/or may include a plurality of radially inwardly extending protrusions on the inner surface. The nut may include an outer surface and a plurality of radially outwardly extending splines on the outer surface. Engaging the intermediate anti-rotation element with the nut may include engaging the radially inwardly extending protrusions of the intermediate anti-rotation element with the radially outwardly extending splines of the nut. In a detailed embodiment, engaging the intermediate anti-rotation element with the nut may include at least one of press fitting, interference fitting, welding, and/or shrink fitting the intermediate anti-rotation element onto the nut.

In a detailed embodiment, the intermediate anti-rotation element may be generally ring shaped, may define a radially outer surface, and/or may include a plurality of radially outwardly extending protrusions on the radially outer surface. The receptacle of the housing may be defined by an inner surface of the housing and/or may include a plurality of grooves extending along an axial direction. Inserting the intermediate anti-rotation element and the nut into the receptacle of the housing may include slidably engaging the plurality of radially outwardly extending protrusions of the intermediate anti-rotation element with the plurality of grooves of the receptacle of the housing.

In a detailed embodiment, the retaining structure may include an internal retaining ring. The receptacle of the housing may be defined by an inner surface of the housing. Inserting the retaining structure into the receptacle may include positioning the retaining structure in frictional engagement with at least a portion of the inner surface of the housing.

In a detailed embodiment, inserting the retaining structure into the receptacle may include inserting the retaining structure into the receptacle so that the intermediate anti-rotation element and the nut are movable relative to the receptacle within at least one of a circumferential gap corresponding to clearance movement in the rotational direction, an axial gap corresponding to clearance movement in the axial direction, and/or a radial gap corresponding to clearance movement in the radial direction. The intermediate anti-rotation element may be generally ring shaped, may define a radially outer surface, and/or may include a plurality of radially outwardly extending protrusions on the radially outer surface. The receptacle of the housing may be defined by an inner surface of the housing and may include a plurality of grooves extending along an axial direction. Inserting the intermediate anti-rotation element and the nut into the receptacle of the housing may include engaging the plurality of radially outwardly extending protrusions of the intermediate anti-rotation element with the plurality of grooves of the receptacle of the housing to form at least one of the circumferential gap, the axial gap, and/or the radial gap.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a perspective view of an exemplary nut retaining device in accordance with the principles of the present disclosure.

FIG. 2 is an exploded perspective view of the nut retaining device of FIG. 1.

FIG. 3 is a bottom view of the nut retaining device of FIG. 1.

FIG. 4 is a perspective view of an exemplary housing of the nut retaining device of FIG. 1.

FIG. 5 is a detailed top view of an exemplary anti-rotation element and an exemplary nut of the nut retaining device of FIG. 1.

FIG. 6A is a cross-section view of the nut retaining device of FIG. 1, illustrating an exemplary blind connection installation.

FIG. 6B is a cross-section view of the nut retaining device of FIG. 1, illustrating an exemplary through-hole connection installation.

### DETAILED DESCRIPTION

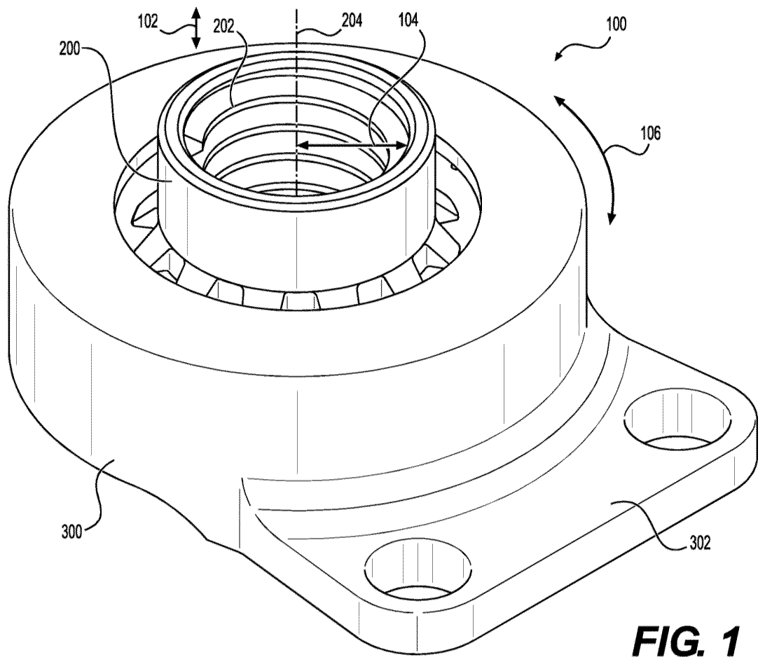

FIG. 1 is a perspective view of an exemplary nut retaining device 100 in accordance with the principles of the present disclosure. In the embodiment shown, the nut retaining device 100 comprises a nut 200 received within a housing 300. The nut 200 includes internal screw threads 202, which are adapted to engage a correspondingly externally threaded fastener and which define a screwing axis 204. In this exemplary embodiment, the nut 200 is retained within the housing 300 so that the nut 200 is capable of limited clearance movements relative to the housing 300, such as in an axial direction 102 (e.g., parallel to the screwing axis 204 of the nut 200), in a radial direction 104 (e.g., radially relative to the screwing axis 204), and/or rotationally 106 (e.g., rotationally about the screwing axis 204). The housing 300 may include an attachment structure, such as a flange 302, configured for fixing the nut retaining device 100 to a base structure.

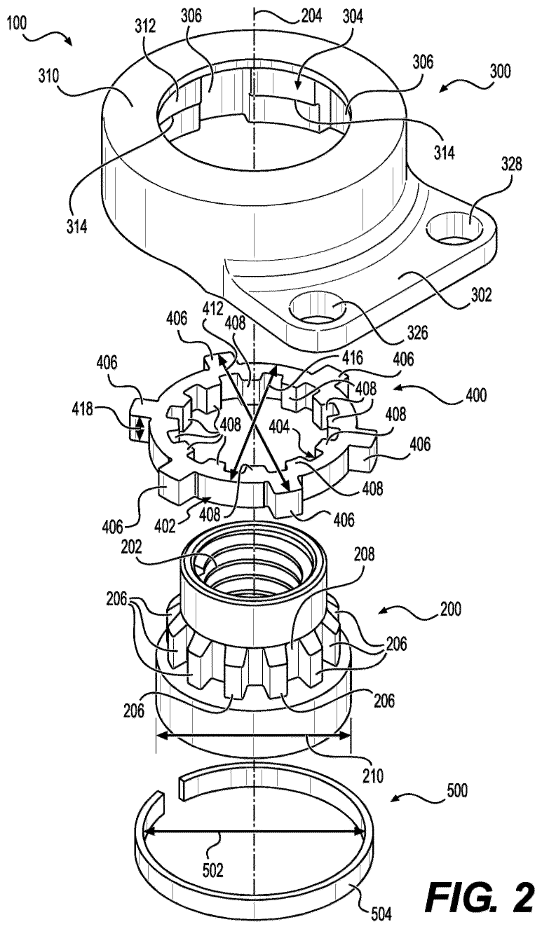

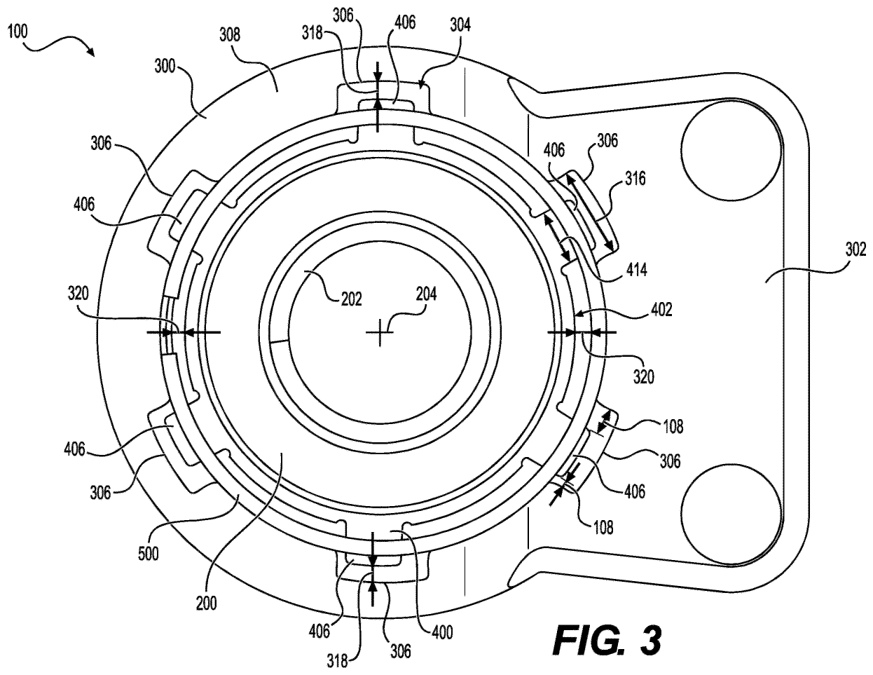

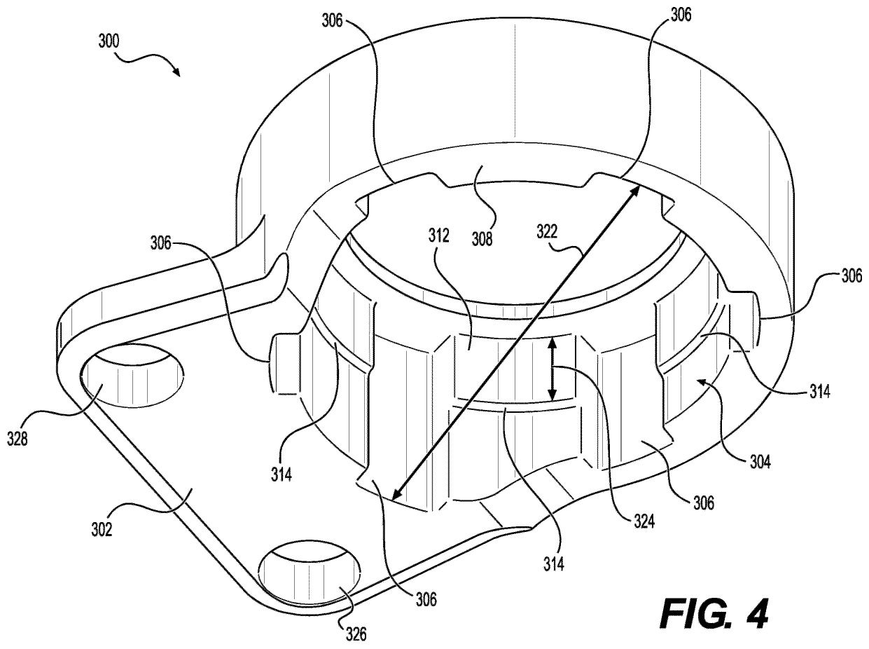

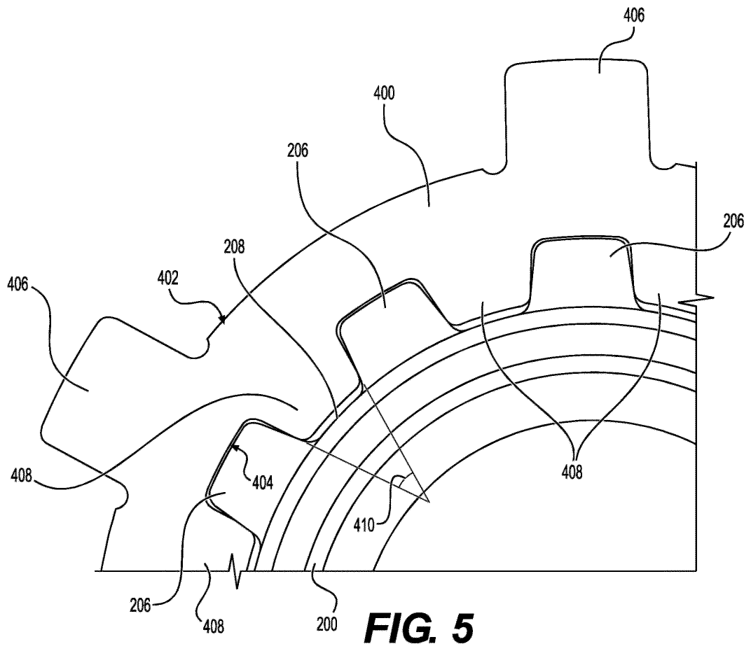

FIG. 2 is an exploded perspective view of the nut retaining device 100, FIG. 3 is a bottom view of the nut retaining device 100, FIG. 4 is a perspective view of the housing 300, and FIG. 5 is a top view of an anti-rotation element and the nut 200 of the nut retaining device of FIG. 1. Referring to FIGS. 2-4, the housing 300 may define an interior receptacle 304. The nut 200 may be received within the interior receptacle 304 of the housing 300.

Referring to FIGS. 1-5, the nut retaining device 100 may include an anti-rotation structure between the housing 300 and the nut 200. For example, the anti-rotation structure may include a first anti-rotation structure on the housing 300 and a second anti-rotation structure on the nut 200, which may cooperate to constrain the nut 200 against rotation relative to the housing 300. In the embodiment shown, the first anti-rotation structure on the housing 300 may include a plurality of grooves 306 extending along the axial direction 102 parallel to the screwing axis 204 of the nut 200 between a second end 308 of the housing 300 adjacent the attachment structure 302 in a direction toward a first end 310 of the housing 300 opposite the second end 308. The grooves 306 may be on an inner surface 312 of the housing 300 that defines the receptacle 304. The second anti-rotation structure on the nut 200 may include a plurality of radially outwardly extending splines 206 on an outer surface 208 of the nut 200.

Referring to FIGS. 2-5, the nut retaining device 100 may include an intermediate anti-rotation element 400, which may be adapted to be received in the receptacle 304 of the housing 300. In the embodiment shown, the intermediate anti-rotation element 400 may be generally ring shaped. The intermediate anti-rotation element 400 may be configured to circumscribe at least a portion of the nut 200. The intermediate anti-rotation element 400 may define a radially outer surface 402 and/or a radially inner surface 404.

In the embodiment shown, the intermediate anti-rotation element 400 may include a third anti-rotation structure, which may be complementary to the first anti-rotation structure of the housing 300. The third anti-rotation structure of the intermediate anti-rotation element 400 may engage the first anti-rotation structure of the housing 300 to provide the axial, radial, and/or rotational clearance movement between the nut and the housing. For example, the third anti-rotation structure may include a plurality of radially outwardly extending protrusions 406 on the outer surface 402 of the intermediate anti-rotation element 400. The protrusions 406 of the third anti-rotation structure may be sized and arranged to engage respective grooves 306 of the housing 300.

Referring to FIGS. 2 and 5, the intermediate anti-rotation element 400 may further include a fourth anti-rotation structure, which may be complementary to the second anti-rotation structure of the nut 200. The fourth anti-rotation structure of the intermediate anti-rotation element 400 may engage the second anti-rotation structure of the nut 200 to constrain the nut 200 against rotation, axial movement, and/or radial movement relative to the intermediate anti-rotation element 400. In the embodiment shown, the fourth anti-rotation structure may include a plurality of radially inwardly extending protrusions 408 on the inner surface 404 of the intermediate anti-rotation element 400.

Referring to FIG. 5, the protrusions 408 of the fourth anti-rotation structure of the intermediate anti-rotation element 400 may engage the splines 206 of the nut 200. The protrusions 408 may be configured with opposite faces arranged toward one another to define an inwardly facing angle 410, which may be configured so that the protrusions 406 engage the splines 206 of the nut 200. In some exemplary embodiments, the intermediate anti-rotation element 400 may be forcibly mounted on the nut 200 so that the intermediate anti-rotation element 400 is deformed to securely couple with the nut 200. In some exemplary embodiments, the intermediate anti-rotation element 400 may be press fit, interference fit, welded, and/or shrink-fit onto the nut 200.

Some exemplary intermediate anti-rotation elements 400 may be constructed from metal, such as a generally planar sheet of metal, by punching, stamping, laser cutting, and/or water cutting. In some exemplary embodiments, the intermediate anti-rotation element 400 may be formed from a more ductile material than the nut 200 to facilitate secure engagement of the intermediate anti-rotation element 400 on the nut 200.

Referring to FIGS. 2-4, the nut retaining device 100 may further include a retaining structure 500 engageable with the nut 200 and configured to retain the nut 200 within the receptacle 304 of the housing 300 in an assembled condition of the device 100. In the embodiment shown, the retaining structure 500 is generally in the form of an internal retaining ring configured to be received within the receptable 304. In some exemplary embodiments, the retaining structure 500 may be constructed from metal, such as stainless steel.

The retaining structure 500 may have an internal diameter 502 that is greater than the largest diameter 210 of the nut 200. The internal diameter 502 of the retaining structure 500 may be less than a maximum diameter 412 of the intermediate anti-rotation element 400. As a result, the retaining structure 500 may retain the intermediate anti-rotation element 400 in the receptacle 304 of the housing 300. With the nut 200 secured to the intermediate anti-rotation element 400, the retaining structure also retains the nut 200 in the receptacle 304 of the housing 300.

The retaining structure 500 may be elastically deformable (e.g., radially compressed) for insertion into the receptacle 304 of the housing 300. In the embodiment shown, an outer surface 504 of the retaining structure 500 may be configured to frictionally engage at least a portion of the inner surface 312 of the housing 300 that defines the receptacle 304. In some exemplary embodiments, the retaining structure 500 may be deformable to create an interference that prevents the nut 200 from being removed from the receptacle 304. For example, in some alternative exemplary embodiments without a retaining structure 500 comprising an internal retaining ring, the retaining structure 500 may be formed as a portion of the housing 300 that is configured to be bent, punched, or crimped to ensure that the nut 200 remains in position. When installed, the retaining structure 500 may prevent the nut 200 from being removed from the receptacle in the course of intended uses of the nut retaining device 100.

The retaining structure 500 may be engaged against an axial stop within the receptacle 304 of the housing 300. For example, referring to FIGS. 2 and 4, the housing 300 may include one or more radially inwardly extending protrusions 314 within the receptacle 304. The retaining structure 500 may be engaged against the protrusions 314 to position the retaining structure 500 within the receptacle 304. For example, each protrusion 314 may include an axially facing shoulder against which the retaining structure 500 may be disposed.

In some exemplary embodiments, the retaining structure 500 may be permanently installed into the housing 300. Accordingly, in some such embodiments, the assembled nut retaining device 100 comprises an inseparable unit (e.g., under intended operating conditions) and/or the nut retaining device 100 may be transported, installed, and/or utilized without risk of inadvertent disassembly or loss of component parts.

As discussed above, the anti-rotation structure between the housing 300 and the nut 200 may be configured to constrain the nut 200 against rotation relative to the housing 300 about the screwing axis 204 of the nut 200. The anti-rotation structure may be configured to allow limited rotational clearance movement of the nut 200 relative to the housing 300, such as to facilitate positioning and installation of a threaded fastener into the nut 200. For example, the anti-rotation structure may allow a rotational clearance movement of the nut 200 relative to the housing 300 of less than about 10 degrees, such as less than or equal to about 7 degrees. Referring to FIG. 3, in the embodiment shown, the outwardly extending protrusions 406 on the outer surface 402 of the intermediate anti-rotation element 400 may have a width 414 that is less than a width 316 of the grooves 306 on the interior of the housing 300 to thereby define a circumferential gap 108. The circumferential gap 108 may allow the limited rotational clearance movement of the nut 200 relative to the housing 300.

As discussed above, the anti-rotation structure between the housing 300 and the nut 200 may be configured to constrain the nut 200 against radial movement relative to the housing 300. The anti-rotation structure may be configured to provide a limited radial clearance movement between the nut 200 and the housing 300, such as to facilitate positioning and installation of a threaded fastener into the nut 200. For example, the anti-rotation structure may allow a clearance movement in the radial direction that is less than about 2.0 mm, such as less than or equal to about 1.0 mm.

Referring to FIGS. 2-4, in the embodiment shown, the intermediate anti-rotation element 400 is sized smaller than the interior dimensions of the receptacle 304 of the housing 300 such that radial gaps 318, 320 are defined between the receptacle 304 and the intermediate anti-rotation element 400. These radial gaps 318, 320 accommodate the clearance movements of the nut 200 in the radial direction relative to the housing 300.

In the embodiment shown, the radial gap 318 is defined by the maximum diameter 412 of the outwardly extending protrusions 406 of the intermediate anti-rotation element 400 and the diameter 322 of the grooves 306 on the interior of the housing 300. In the embodiment shown, the radial gap 320 is defined by the diameter 416 of the intermediate anti-rotation element 400 between the outwardly extending protrusions 406 and the diameter of the interior surface 312 of the receptacle 304 between the grooves 306.

Described in another way, in the embodiment shown, the protrusions 406 have a width (e.g., diameter 412) in a plane perpendicular to the axial direction 102 (FIG. 1) that is less than a width (e.g., diameter 322) of the corresponding grooves 306 by an amount (e.g., radial gap 318) that provides the clearance movement in the radial direction 104 (FIG. 1).

As, discussed above, the anti-rotation structure between the housing 300 and the nut 200 may be configured to constrain the nut 200 against axial movement relative to the housing 300. The anti-rotation structure may be configured to provide a limited axial clearance movement between the nut 200 and the housing 300, such as to facilitate positioning and installation of a threaded fastener into the nut 200. For example, the anti-rotation structure may allow a clearance movement in the axial direction 102 (FIG. 1) of less than about 3.0 mm, such as less than or equal to about 1.5 mm.

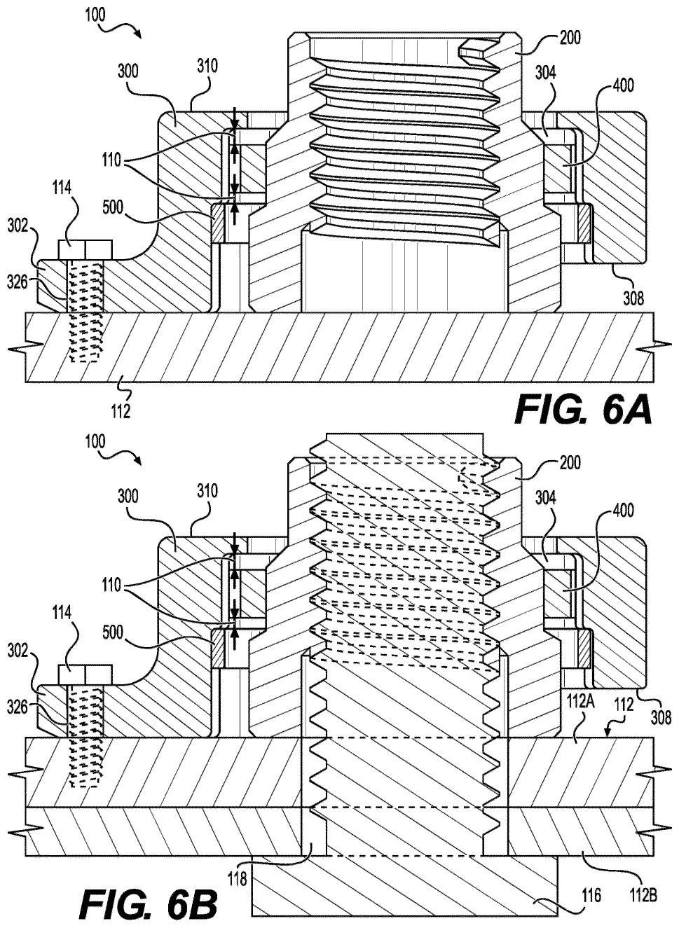

Referring to FIGS. 2 and 4, in the embodiment shown, the receptacle 304 defines a length 324 in the axial direction 102 (FIG. 1) relative to the retaining structure that is greater than the dimensions (e.g., thickness 418) of the intermediate anti-rotation element 400, specifically the protrusions 406, in the axial direction 102 (FIG. 1) such that an axial gap 110 (see FIGS. 6A and 6B) is provided that accommodates clearance movement in the axial direction 102 (FIG. 1).

In the embodiment shown, the rotational, axial, and/or radial clearance movements may facilitate positioning and threading of the threaded fastener into the nut 200, even when the nut retaining device 100 is not accessible, or is only limitedly accessible, by allowing limited movement(s) to accommodate minor misalignment and/or manufacturing tolerances.

In some exemplary embodiments, the nut 200 may be configured to prevent unintended rotation with respect to the threaded fastener. For example, the nut 200 may be configured to provide self-locking of the threads when threadedly engaged with the threaded fastener. As non-limiting examples, self-locking features of the nut may include, for example, plastic inserts and/or deformable threads. Various other structures or methods may alternatively be used that are suitable to prevent unintended rotation.

In some exemplary embodiments, the nut 200 may comprise a standard, off-the-shelf nut. In some circumstances, certain standard, off-the-shelf nuts may be the subject of preexisting analyses, approvals, and/or certifications. Accordingly, utilizing such a nut may facilitate approval and/or certification of the nut retaining device 100, such as by civil aviation authorities or under other qualification requirements.

Housing 300 may be manufactured by any suitable manufacturing method. In some exemplary embodiments, the housing 300 may be formed by casting and/or 3D printing, for example.

FIG. 6A is a cross-section view of the nut retaining device 100 of FIG. 1, illustrating an exemplary blind connection installation, and FIG. 6B is a cross-section view of the nut retaining device 100 of FIG. 1, illustrating an exemplary thru-hole type connection installation. Referring to FIGS. 2, 6A, and 6B, some exemplary nut retaining devices 100 according to at least some aspects of the present disclosure may be installed on a base structure 112, such as by using one or more threaded fasteners 114 to secure the housing 300 to the base structure. For example, one or more threaded fasteners 114 may extend through one or more holes 326, 328 through the flange 302 of the housing 300. In alternative embodiments, one or more rivets or other fasteners may be used to secure the housing 300 to the base structure 112.

In some exemplary installations, the base structure 112 may comprise a single-layer base structure 112, as is shown in FIG. 6A. In some exemplary installations, the base structure 112 may comprise two or more base structure layers 112A, 112B, as is shown in FIG. 6B.

Referring to FIG. 6A, in some exemplary installations, the nut retaining device 100 may be arranged such that the nut 200 is configured to receive a threaded fastener that does not extend through the base structure 112. This arrangement may be referred to as a blind connection installation.

Referring to FIG. 6B, in some exemplary installations, the nut retaining device 100 may be arranged such that the nut 200 is configured to receive a threaded fastener 116 that extends through the base structure 112 and into the nut 200. For example, the nut 200 may be threadedly engaged with a threaded fastener 116 extending through one or more thru-holes 118 in the base structure 112. Exemplary methods of installing a nut retaining device 100 according to at least some aspects of the present disclosure may include one or more of the following operations. The nut retaining device 100 may be mounted to the base structure 112. For example, the flange 302 of the housing of the nut retaining device 100 may be secured to the base structure 112, such as by one or more threaded fasteners 114 and/or rivets. Mounting the nut retaining device 100 to the base structure 112 may include aligning the nut 200 of the nut retaining structure 100 with the through hole 118 of the base structure 112 so that a threaded fastener 116 may extend through the through hole 118 and into threaded engagement with the nut 200.

Exemplary methods of using a nut retaining device 100 according to at least some aspects of the present disclosure may include one or more of the following operations. The threaded fastener 116 may be generally aligned with the screwing axis 102 of the nut 200 of the nut retaining device 100. The threaded fastener 116 may be threadedly engaged with the internal screw threads 202 of the nut 200. Engaging the threaded fastener 116 with the internal screw threads 202 of the nut 200 may include moving the nut 200 with respect to the housing 300 rotationally, axially, and/or radially. Moving the nut 200 with respect to the housing 300 rotationally, axially, and/or radially may include moving the nut 200 within the rotational, axial, and/or radial clearance movements provided by the engagement between the intermediate anti-rotation element 400 and the receptacle 304 of the housing.

Exemplary methods of making a nut retaining device 100 according to at least some aspects of the present disclosure may include one or more of the following operations. The housing 300, the nut 200, the intermediate anti-rotation structure 400, and/or the retaining structure 500 may be fabricated by any suitable method. As non-limiting examples, fabricating the housing 300, the nut 200, the intermediate anti-rotation structure 400, and/or the retaining structure 500 may include casting, milling, machining, drilling, punching, stamping, laser cutting, and/or water cutting, and/or 3D printing.

The intermediate anti-rotation element 400 may be engaged with the nut 200. The intermediate anti-rotation element 400 and the nut 200 may be inserted into the receptacle 304 of the housing 300. The retaining structure 500 may be inserted into the receptacle 304 so that the intermediate anti-rotation element 400 and the nut 200 are retained within the receptacle 304 and the nut 200 is capable of clearance movement relative to the housing 300 in at least one of the rotation direction 106 rotationally about the screwing axis 204 of the nut 200, or the axial direction 102 parallel to the screwing axis of the nut 204, or the radial direction 104 relative to the axial direction 102 that is parallel to the screwing axis 204 of the nut 200.

Engaging the intermediate anti-rotation element 400 with the nut 200 may include engaging the radially inwardly extending protrusions 408 of the intermediate anti-rotation element 400 with the splines 206 of the nut 200. Engaging the intermediate anti-rotation element 400 with the nut 200 may include at least one of press fitting, interference fitting, welding, and/or shrink fitting the intermediate anti-rotation element 400 onto the nut 200.

Inserting the intermediate anti-rotation element 400 and the nut 200 into the receptacle 304 of the housing 300 may include slidably engaging the radially outwardly extending protrusions 406 of the intermediate anti-rotation element 400 with the grooves 306 of the receptacle 304 of the housing 300.

The retaining structure 500 may include an internal retaining ring. Inserting the retaining structure 500 into the receptacle 304 may include positioning the retaining structure 500 in frictional engagement with at least a portion of the inner surface 312 of the housing 300. Inserting the retaining structure 500 into the receptacle 304 so that the intermediate anti-rotation element 400 and the nut 200 are movable relative to the receptacle 304 within at least one of a circumferential gap 108 corresponding to clearance movement in the rotational direction 106, an axial gap 110 corresponding to clearance movement in the axial direction 102, or a radial gap 318, 320 corresponding to clearance movement in the radial direction 104. Inserting the intermediate anti-rotation element 400 and the nut 200 into the receptacle 304 of the housing 300 may include engaging the radially outwardly extending protrusions 406 of the intermediate anti-rotation element 400 with the grooves 306 of the receptacle 304 of the housing 300 to form at least one of the circumferential gap 108, the axial gap 110, and the radial gap 318, 320. While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

1. A nut retaining device, comprising:
a housing defining an interior receptacle, the housing including attachment structure configured for fixing the housing to a base structure;
a nut received within the receptacle and having screw threads adapted to engage a correspondingly threaded fastener;
anti-rotation structure between the housing and the nut;
the anti-rotation structure constraining the nut against rotation relative to the housing about a screwing axis of the nut;
the anti-rotation structure configured to provide a clearance movement between the nut and the housing in at least one of:
a rotation direction rotationally about the screwing axis of the nut, or
an axial direction parallel to the screwing axis of the nut, or
a radial direction relative to the axial direction that is parallel to the screwing axis of the nut; and
retaining structure engageable with the nut and retaining the nut within the receptacle.

2-21. (canceled)
